(19) United States
(12) Patent Application Publication
(10) Pub. No.: US 2002/0134821 A1
(43) Pub. Date: Sep. 26, 2002

(54) Postal item

(76) Inventor: Kyle Gradus-Samson, Green Point (ZA)

Correspondence Address: HELLER EHRMAN WHITE & MCAULIFFE LLP, SUITE 300, 101 ORCHARD RIDGE DR., GAITHERSBURG, MD, 20878-1917, US

(21) Appl. No.: 09/987,447

(22) Filed: Nov. 14, 2001

(30) Foreign Application Priority Data
Mar. 22, 2001 (ZA) 2001/2361

(51) Int. Cl. B42D 15/00; G09F 1/00; A47G 1/06

(52) U.S. Cl. 229/92.8; 40/124.06; 40/776

(57) ABSTRACT

A postal item is disclosed which includes a blank having a first surface providing an area which can be written on and a transparent sheet secured around its edges to a second opposed surface of the blank. The blank and sheet form between them a pocket in which is received a sheet on which there is visual material. The blank has a main area and edge zones which are folded over to sandwich the edges of said transparent sheet between themselves and the main area of the blank thereby to form a pocket in which the sheet with visual material on it is received. A portion of the blank is bounded by a line of weakness and joined to the remainder of the blank along a line about which said blank can be bent. Once bent the portion protrudes from the remainder of the blank and forms a stand.

### FIELD OF THE INVENTION

THIS INVENTION relates to a postal item.

### BACKGROUND TO THE INVENTION

Various postal items are in extensive use. Normal sealed envelopes, which may have a transparent window, and postcards are widely used.

People on vacation usually send postcards to friends and relatives. These quite often depict the scenery in the area where the people are vacationing. In addition people at home send pictures to friends and relatives simply to stay in touch.

Applicant believes that many vacationers would like to send a more personal photograph home than is constituted by an “off-the-shelf” postcard. Applicant also believes that people at home need a simple and efficient means of sending a photograph or other visual material through the mail.

Accordingly, the main object of the present invention is to provide a postal item that enables a photograph or other visual material to be posted.

A subsidiary object of the present invention is to provide a postal item that can be displayed after receipt by the addressee.

Applicant is aware of U.S. Pat. No. 6,189,774B1 which discloses a postcard for mailing and displaying a photograph.

### BRIEF DESCRIPTION OF THE INVENTION

According to one aspect of the present invention there is provided a postal item including a blank having a first surface providing an area which can be written on and a transparent sheet secured around its edges to a second opposed surface of the blank thereby to form, between itself and the blank, a pocket in which a sheet on which there is visual material can be inserted, said blank having a main area and edge zones which are folded over to sandwich the edges of said transparent sheet between themselves and said main area of the blank.

Preferably first and second portions of said blank are bounded by lines of weakness and are each joined to the remainder of the blank along lines about which said blank can be bent so that said portions protrude from the remainder of the blank and forms stands, the stands being such that the postal item can be displayed in the orientation designated portrait and in the orientation designated landscape.

According to a further aspect of the present invention there is provided an assembly of components from which a postal item can be constructed, the components comprising a blank having a main area one surface of which can have an address applied thereto, edge zones of the blank protruding outwards from said main area, said edge zones, when folded over with respect to the remainder of the blank, overlying portions of said main area, and a transparent sheet which, when positioned on that surface of said blank which is opposed to said one surface, can be attached to said blank by folding said edge portions over and adhering them to said transparent sheet.

Said first and second portions of the blank of the assembly can be bounded by lines of weakness and each can be joined to the remainder of the blank along lines about which said blank can be bent so that said portions protrude from the remainder of the blank and forms stands, the stands being such that the postal item can be displayed in the orientation designated portrait and in the orientation designated landscape.

Preferably said edge zones are of irregular shape and, once folded over, form a frame which bounds an area having the shape of a recognisable manmade or natural geographic location. In this form the edge zones are preferably printed with decorative material which pertains to the place from which the postal item is to be mailed or can be printed with material which relates to an event or attraction or can be printed with a greeting.

According to another aspect of the present invention there is provided a postal item which comprises a blank which can be folded in half to form a pocket for receiving visual material to be displayed, edge zones of one half of the blank protruding outwardly from a main area of said one half, said edge zones, when folded over with respect to the remainder of said one half, overlying portions of said main area, and an opening in the other half of the blank, said opening being of irregular shape and surrounded by a frame the inner edge of which bounds said opening, the opening having the shape of a recognisable manmade or natural geographic location.

The frame of this form of postal item can be printed with decorative material which pertains to the place from which the postal item is to be mailed or can be printed with material which relates to an event or attraction or can be printed with a greeting. First and second portions of the blank are preferably bounded by lines of weakness and are each joined to the remainder of the blank along lines about which said blank can be bent so that said portions protrude from the remainder of the blank and forms stands, the stands being such that the postal item can be displayed in the orientation designated portrait and in the orientation designated landscape.

### BRIEF DESCRIPTION OF THE DRAWINGS

For a better understanding of the present invention, and to show how the same may be carried into effect, reference will now be made, by way of example, to the accompanying drawings in which:—

FIG. 1 is a plan view of a blank which constitutes one component of a postal item;

FIG. 2 is a plan view of a transparent sheet which forms another component of the postal item;

FIG. 3 diagrammatically illustrates the way in which the components are assembled to form the postal item;

FIG. 4 illustrates the way in which the postal item can be displayed;

FIG. 5 is a plan view of a further blank;

FIG. 6 is a view of the blank of FIG. 5 with edge zones thereof folded over; and

FIG. 7 is an elevation of a further postal item.

### DETAILED DESCRIPTION OF THE DRAWINGS

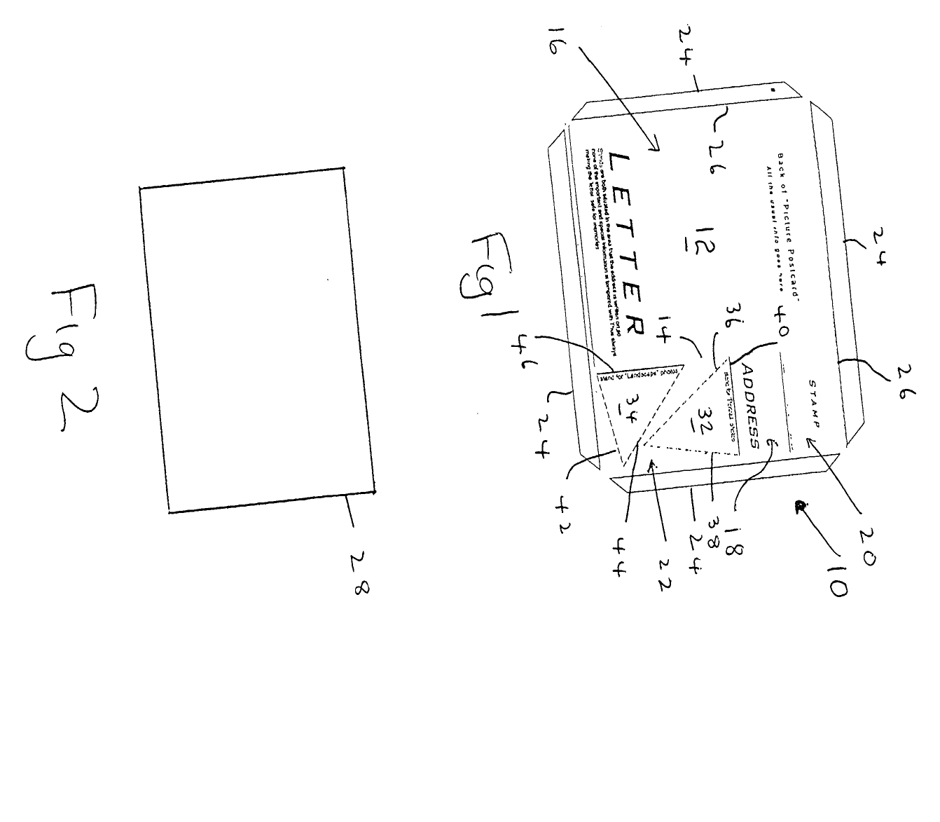

Referring firstly to FIG. 1, the component 10 illustrated is in the form of a cardboard blank having a main area designated 12. Printed lines 14 divide the area 12 up into a field 16 for correspondence, a field 18 for an address and a field 20 to which a stamp can be affixed. The remaining part 22 of the main area 12 is perforated so that panels can be folded out to form a stand. This will be described in more detail hereinafter.

The rectangular main area 12 is extended, on all four sides, by edge zones designated 24. The boundary between each edge zone and the main area 12 is marked by a line 26 which can simply be printed or can be pre-creased or pre-perforated. Each end of each edge zone 24 is mitred off at 45°. The rear surface of each edge zone, that is, the surfaces which are not visible in FIG. 1, have thereon an adhesive. The adhesive can be a contact adhesive. It can also be an adhesive which is activated by being moistened.

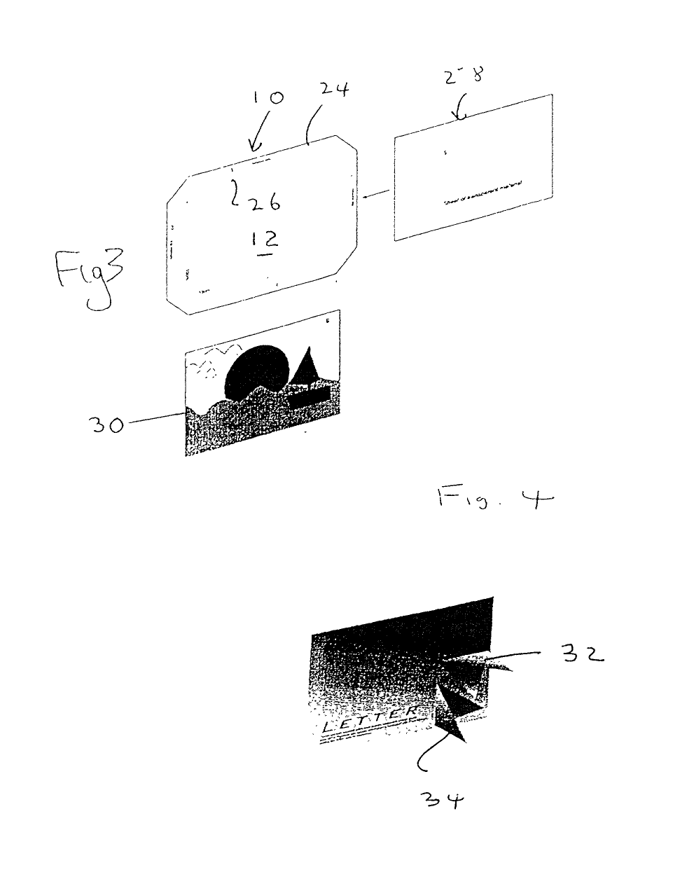

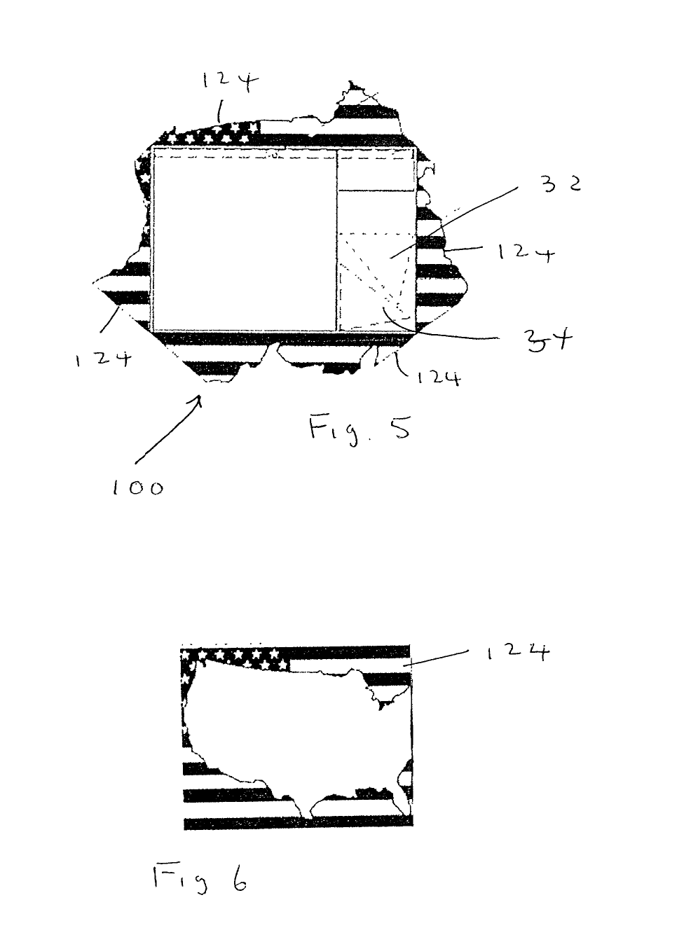

The sheet 28 shown in FIG. 2 is transparent and its dimensions substantially match those of the main area 12. The sheet 28 is of a synthetic plastics material and is of sufficient thickness to withstand the rigours of being posted by the sender and delivered to the recipient after passing through the various stages of sorting etc to which it is subjected by the postal authorities.

Before the postal item is retailed, the sheet 28 is placed on the component 10 and three of the four edge zones are adhered to the transparent sheet 28. This forms a pocket which is open along one side and into which the sender can insert the visual material to be sent before adhering the fourth edge zone to the sheet. This completely closes the pocket in which the visual material is contained.

The remaining part 22 of the component 10 is configured so as to provide two triangular panels 32 and 34. The panel 32 is bounded by two intersecting lines of perforations 36 and 38 which are joined to one another by a crease line 40. Likewise, the panel 34 is bounded by two intersecting lines of perforations 42, 44 joined by a crease line 46. The panels 32, 34 constitute stands, the one which is used depending on whether the visual material is in landscape or portrait format.

When the component 10 is split along the lines of perforations 36, 38 and then folded along the crease line 40 it can be stood with its larger dimension extending upwardly and its smaller dimension extending horizontally. Conversely, if it is the panel 34 which is detached from the remainder of the component 10 by splitting the component 10 along the lines of perforations 42, 44 and folding about the crease line 46, then the postal item will stand with its major dimension horizontal and its minor dimension vertical. It will be appreciated that the positioning of the panels 32, 34 is such that when either of the stands is in use the postal item is slightly inclined to the vertical for stability and display purposes.

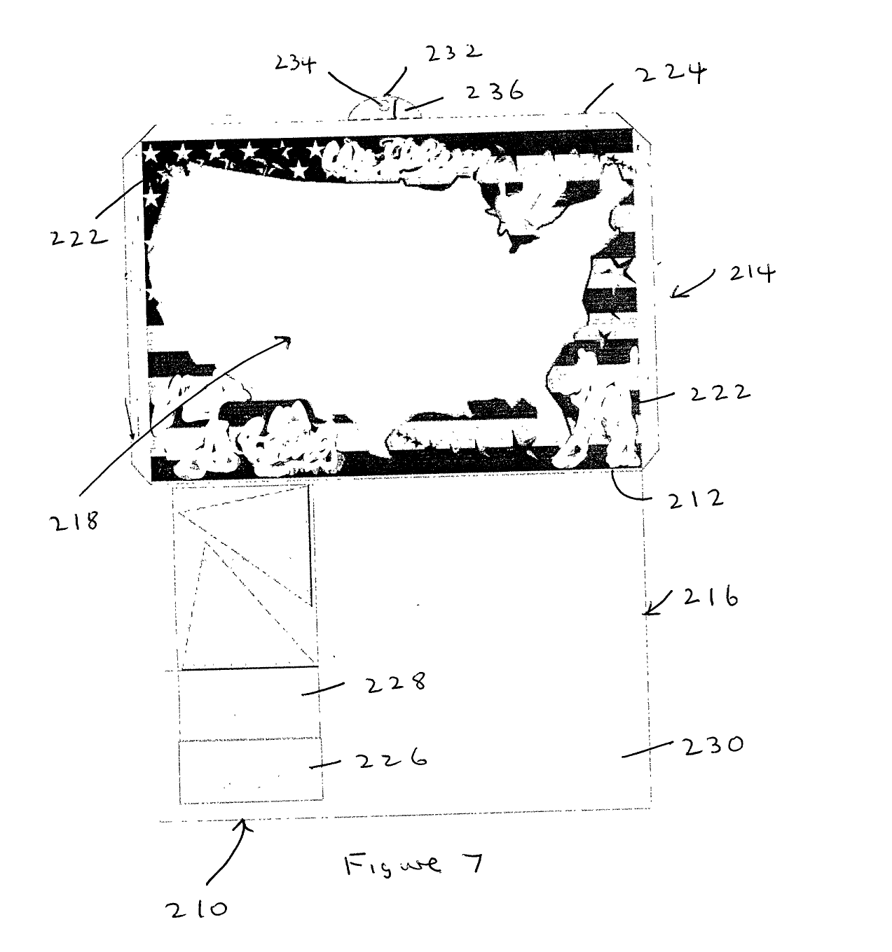

In FIG. 5 the component 100 has edge zones 124 which are not of the simple shape shown in FIG. 1. The edge zones can be cut to any shape, the shape chosen being dependant on the shape that the frame around the visual material on the sheet 30 is to have. In FIG. 6 they are cut to form a map of the United States.

Turning now to FIG. 7, the postal item component illustrated is designated 210 and is in the form of a cardboard blank which is approximately twice the area that the postal item has when ready for mailing.

A fold line is shown at 212 and this divides the component into two parts designated 214 and 216. The part 214 has an opening 218 cut in it. The opening 218, in the illustrated embodiment, has the shape of the map of the United States. Any other shape could be chosen such as the map of a specific state or the shape of a famous building or the shape of a mountain range.

Around the opening 218 there is a frame 220 the inner edge of which defines the opening. The four outer edges of the frame define a rectangle. This is bounded by three edges designated 222 and by the fold line 212.

The frame 220 is printed with decorative material pertaining to the place from which the postal item it is to be mailed or can be printed with material pertaining to a specific event or attraction or can be printed with a greeting.

The edges 222 can be formed by crease lines or by pre-printed lines. Outwardly of three of the edges 222 there are elongate edge zones 224. The ends of the edge zones 224 are mitred-off at 45 degrees.

The part 216 is sub-divided by printing into a field 226 for a postal stamp, a field 228 for an address, and a field 230 for a written message.

The part 214 is extended by a small panel 232 which forms a wall mount. The panel 232, a small part of the right hand side of which is shown cut away, has a hole 234 in it so that the postal item can be suspended from a hook or pinned to a board.

A piece 236 of the material known as plastic magnet or fridge magnet can be adhered to the rear of the panel 232 so that the mail item can be “stuck” on a fridge door.

A transparent sheet, not shown in FIG. 7 but identical to the sheet 28 of FIG. 2, forms the second component of the postal item.

To prepare the postal item for mailing the component 210 is turned over from the position illustrated and placed face down. The transparent sheet is then placed over the opening 218 so that it overlies the opening 218 and the frame 220 and covers the whole rectangular area bounded by the edges 222 and fold line 212. The visual material is then trimmed, if necessary, to the size of the rectangular area and placed face down on the transparent sheet.

The blank is then folded along the line 212 so that the part 216 overlies the part 214. The next step is to fold over the three edge zones 224 and adhere them to the part 216. The postal item is now closed. The visual material is between the part 216 and the transparent sheet and visible through the opening 218.

Once delivered the postal item can be displayed using one or other of the stands, or hung using the wall mount.

1. A postal item including a blank having a first surface providing an area which can be written on and a transparent sheet secured around its edges to a second opposed surface of the blank thereby to form, between itself and the blank, a pocket in which a sheet on which there is visual material can be inserted, said blank having a main area and edge zones which are folded over to sandwich the edges of said transparent sheet between themselves and said main area of the blank.

2. A postal item as claimed in claim 1, wherein first and second portions of said blank are bounded by lines of weakness and are each joined to the remainder of the blank along lines about which said blank can be bent so that said portions protrude from the remainder of the blank and forms stands, the stands being such that the postal item can be displayed in the orientation designated portrait and in the orientation designated landscape.

3. An assembly of components from which a postal item can be constructed, the components comprising a blank having a main area one surface of which can have an address applied thereto, edge zones of the blank protruding outwards from said main area, said edge zones, when folded over with respect to the remainder of the blank, overlying portions of said main area, and a transparent sheet which, when positioned on that surface of said blank which is opposed to said one surface, can be attached to said blank by folding said edge portions over and adhering them to said transparent sheet.

4. An assembly as claimed in claim 3, wherein first and second portions of said blank are bounded by lines of weakness and are each joined to the remainder of the blank along lines about which said blank can be bent so that said portions protrude from the remainder of the blank and forms stands, the stands being such that the postal item can be displayed in the orientation designated portrait and in the orientation designated landscape.

5. An assembly as claimed in claim 3, wherein said edge zones are of irregular shape and, once folded over, form a frame which bounds an area having the shape of a recognisable man made or natural geographic location.

6. An assembly as claimed in claim 5, wherein said edge zones are printed with decorative material which preferably pertains to the place from which the postal item is to be mailed, to an event or to an attraction .

7. A postal item which comprises a blank which can be folded in half to form a pocket for receiving visual material to be displayed, edge zones of one half of the blank protruding outwardly from a main area of said one half, said edge zones, when folded over with respect to the remainder of said one half, overlying portions of said main area, and an opening in the other half of the blank, said opening being of irregular shape and surrounded by a frame the inner edge of which bounds said opening, the opening having the shape of a recognisable manmade or natural geographic location.

8. A postal item as claimed in claim 7, wherein said frame is printed with decorative material which preferably pertains to the place from which the postal item is to be mailed, to an event or to an attraction.

9. A postal item as claimed in claim 7 or 8, wherein first and second portions of said blank are bounded by lines of weakness and are each joined to the remainder of the blank along lines about which said blank can be bent so that said portions protrude from the remainder of the blank and forms stands, the stands being such that the postal item can be displayed in the orientation designated portrait and in the orientation designated landscape.
